(19) United States
(12) Patent Application Publication
(10) Pub. No.: US 2012/0261016 A1
(43) Pub. Date: Oct. 18, 2012

(54) IMPREGNATION OF LINERS FOR CANAL RENOVATION

(75) Inventors: Nils Fuechtjohann, Greven (DE); Reinhard Lorenz, Steinfurt (DE)

(73) Assignee: SAERTEX MULTICOM GMBH, Saerbeck (DE)

(21) Appl. No.: 13/444,304

(22) Filed: Apr. 11, 2012

(30) Foreign Application Priority Data
Apr. 13, 2011 (DE) 10 2011 002 032.2

(51) Int. Cl. F16L 11/00; B05D 1/18

(52) U.S. Cl. 138/118; 427/434.2

(57) ABSTRACT

The invention relates to an impregnated fiber hose for internal lining of canals and pipelines, a process of manufacturing the same, the use of the fiber hose, and a correspondingly renovated canal or a correspondingly renovated pipeline.

### FIELD OF THE INVENTION

The invention relates to an impregnated fiber hose for internal lining of canals (e.g. sewers) and pipelines, a process of manufacturing the same, the use of the fiber hose, and a correspondingly renovated canal or a correspondingly renovated pipeline.

### RELATED ART

So far, a drain pipe in need of renovation has been renovated in that a resin-soaked fiber hose (hereinafter referred to as “liner”) has been inserted into the pipe in need of renovation. To prevent the resin from flowing out of the fiber hose, a protection film screening the hose from UV light is normally attached to the outside of the fiber hose. Inside the fiber hose a film tube is normally provided as an installation aid. If the impregnated fiber hose is inserted into the pipe in need of renovation, the outer protection film is cut open at the beginning and the end of the fiber hose projecting from the pipe in need of renovation. In the prior art technology, a considerable amount of impregnation composition flows out of the impregnated fiber hose and contaminates the gloves and the other clothing or the tools of the persons renovating the pipe. Further, contamination of the UV lights, which become very hot during operation so that the resin carbonizes, is particularly disadvantageous. Then a connecting piece, generally in the form of a metal cylinder (hereinafter referred to as “packer”), is inserted at the beginning and the end of the internal film tube. Through this packer compressed air is then blown into the internal film tube such that the impregnated fiber hose firmly bears upon the inner wall of the pipe to be renovated. Then normally a chain of lights comprising UV lights is inserted through the packer into the pipe to be renovated in order to subsequently harden the not yet hardened resin of the impregnation composition by means of UV light.

DE 10 2004 059 883 A1 describes a method for renovating pipelines, wherein the impregnation composition is thickened with the aid of an inorganic thickener and then the fiber hose is impregnated with the impregnation composition. This is of disadvantage in that, when inorganic thickeners are used, the thickening effect occurs relatively quickly and is relatively difficult to stop such that some impregnation methods virtually cannot be performed or are very difficult to perform. Thickening is required to prevent large quantities of the impregnation composition from flowing out of the impregnated fiber hose when the protection film is cut open.

DE 41 10 713 A1 describes the manufacture of pipes, wherein a typical composition for producing polyurethane with a very high isocyanate proportion is used for soaking fiber bands and for subsequently manufacturing pipes from the soaked fiber bands.

WO 2009/056312 A2 describes a pipe lining system, wherein a non-woven fabric is impregnated with a typical prepolymeric composition for a polyurethane with a high isocyanate proportion, is inserted into a pipe using an inversion method, and then the urethane composition is cured to give polyurethane.

DE 603 16 846 T2 describes a lining material for pipelines. Here, a lining material is soaked with a binding agent. This binding agent can be selected from various options, such as isocyanate.

DE 199 02 456 A2 describes a method for manufacturing a glass fiber reinforced plastic pipe, wherein a resin composition is centrifuged to the inside of the pipe with the aid of centrifugal machines.

### SUMMARY OF THE INVENTION

It is an object of the present invention to eliminate the disadvantages of the prior art. With the aid of inorganic thickening agents according to the state of liner technology, mostly MgO, Mg(OH)₂ or CaO in the form of powder of paste, above all highly stiff thickened states can be produced which are characterized by viscosities of more than 1 million mPas. An example of this is Luvatol EK 25 NV in concentrations of 2-3%. Normally these systems are of disadvantage in that they do not show any residual flowability since the viscosity increases continuously and does not lead to saturation. As a result, liners thus thickened are very difficult to be inserted into the canal reach due to their low flexibility and can only very slowly be erected by means of compressed air in the canal reach. On the one hand, this results in a deterioration of the installation behavior of the liners with increasing storage time, and on the other hand, there is a growing risk that the hardened liner becomes untight since microscopic air canals may be formed in the liner material when the liner is deformed during erection. In particular, it is an object to formulate the impregnation composition such that it allows for a problem-free impregnation in the low-viscosity state. Then the impregnation composition is to thicken during storage of the liner in the first days after production to such an extent that it does not flow out of the liner when the outer protection film is cut open. Further, the impregnation composition, even after having been stored for several months, is to be capable of ensuring an overall wetting of the complete glass fiber mat when the liner is erected in the sewer pipe. Further, it is an object to ensure that the impregnation composition remains partially flowable, i.e. the impregnation composition must show a residual flowability in the thickened state. In addition, it is an object to ensure that the newly developed liner remains tight and the mechanical characteristics do not deteriorate. Further, the curing rate must not be reduced, if possible.

### DETAILED DESCRIPTION OF THE INVENTION

According to a first embodiment, the object of the invention is achieved by an impregnated fiber hose used for internal lining of canals and pipelines, characterized in that the impregnation comprises at least one resin which is not or only partially through-polymerized and from 0.1 to 20 parts by weight of an isocyanate, based on 100 parts by weight of resin.

Surprisingly, it has been found that, in contrast to inorganic thickeners, the impregnation composition did not rapidly become pasty to be then difficult to process. On the contrary, at the beginning the impregnation composition shows a relatively low viscosity due to this low proportion of isocyanate as a thickener, and can easily be placed onto and into the fiber hose using various impregnation methods. It is another advantage of the low proportion of isocyanate as a thickener in the impregnation composition that, owing to the weight proportion according to the invention, the impregnation composition reaches a high, but not too high, viscosity only at a later point of time when the fiber hose has already been impregnated, and thus, when the pipes are being renovated, the impregnation composition does not flow out when the outer protection film is cut open. Surprisingly, it has turned out that exactly the parts by weight of isocyanate according to the invention in relation to the resin have resulted in the fact that, for example during renovation of pipes, the impregnated fiber hose is still flexible enough, e.g., to be folded without any problems, to be inserted into a pipe in need of renovation, and then to be rapidly erected. On the other hand, it has been found that due to the weight proportion of isocyanate according to the invention in relation to the resin, the impregnation composition can no longer flow out when the outer protection film is cut open and is highly viscous to a sufficient extent. The fiber hose according to the invention helped to solve another problem encountered in the prior art. When the fiber hose is inserted into a pipe in need of renovation, for example, and also when the fiber hose is subsequently inflated, the fibers can move through the impregnation composition and create cavities if the viscosity is too high. This problem could be solved with the fiber hose impregnated according to the invention since it has turned out that with the proportion of isocyanate according to the invention in relation to the resin these cavities are subsequently filled again and the tightness of the fully hardened liner is not affected when the renovation work is completed.

Preferably, the impregnation composition shows a residual flowability.

In the impregnated fiber hose the viscosity of the impregnation (equivalent to the impregnation composition) is preferably at least 700 mPas, more preferably at least 1000 mPas. Irrespective of this, the viscosity of the impregnation composition does not exceed 50,000 mPas, in particular not 10,000 mPas. When the outer protection film is cut open during renovation of pipes it can thus be ensured that the impregnation composition does not flow out and does not contaminate the clothing, for example. Irrespective of this, a certain residual flowability is thus maintained. The viscosity is measured at 25° C. The pressure amounts to atmospheric pressure. The viscosity is measured with a Brookfield viscometer and a spindle CC-14 (at 18.7 rpm and a shear rate of 37.4). The diameter of the measuring chamber is 47 mm at a height of 100 mm. The measured value is obtained two minutes after beginning of the measurement. In all other respects, the measuring conditions of DIN 53018 shall apply.

Preferably, the impregnation is through-polymerized at the most to such an extent that up to 95% by weight of the resin are available as monomers or oligomers, in particular up to 80% by weight of the resin are available as monomers or oligomers. Oligomers within the meaning of the invention are characterized in that they respectively comprise not more than 20 monomer units. This low proportion of through-polymerized resin offers the advantage that prior to hardening of the resin the impregnation composition can better uniformly disperse along the fiber hose and can then be polymerized out in a particularly homogeneous manner.

The NCO content of the isocyanate (according to DIN EN ISO 11909) ranges between 10 and 25%, for example. The isocyanate can be aliphatic, for example. Irrespective of this, the isocyanate can be a trimer, in particular a HDI trimer. The density of the isocyanate at 20° C. according to DIN EN ISO 2811 may range between 1.0 and 1.3 g/ml, in particular between 1.1 and 1.2 g/ml.

It has been found that such isocyanates are particularly well suited for ensuring that the impregnation composition is still of sufficiently low viscosity during the impregnation process and is later of sufficiently high viscosity during renovation of defective pipes such that the impregnation composition does not flow out of the fiber hose.

Preferably, the proportion of the isocyanate ranges between 0.3 and 7 parts by weight, in particular between 1 and 3 parts by weight, based on 100 parts by weight of resin. Surprisingly, it has been found that this preferred proportion of isocyanate in relation to the resin resulted in a particularly good processability during the impregnation process.

The resin preferably is a polyester resin or a vinyl ester resin. These resins turned out to be particularly well suited for achieving the aforementioned desired viscosity development.

For example, the impregnation contains a commonly used photoinitiator or an initiator activated by heat.

The material of the fiber hose is a woven fabric, a non-crimp fabric, a mat, a cord, a non-woven fabric, a felt or a combination of these textile fabrics, for example. The material of the fiber hoses can be glass fiber or thermoplastic polymer in the form of fibers, for example. The material of the fibers can also be a mixture of glass fibers and thermoplastic fibers. Thermoplastic fibers can be made of polypropylene, polyethylene or polyester, for example.

If the impregnation contains any inorganic thickener at all, the proportion of inorganic thickener in the impregnation is preferably less than 0.3 parts by weight, more preferably less than 0.1 parts by weight, based on 100 parts by weight of resin. Thus it can be ensured that the viscosity does not become too high too rapidly during impregnation of the fiber hose, which would make dipping in an immersion bath impossible or lead to clogging of the spray nozzles.

In another embodiment the object of the invention is achieved by a process for manufacturing the fiber hose according to the invention, characterized in that at least the following process steps are carried out: producing an impregnation composition containing at least 0.1 to 20 parts by weight of an isocyanate and 100 parts by weight of unpolymerized resin, and impregnating the material of the fiber hose with the thus produced impregnation composition.

Preferably, the material of the fiber hose is impregnated by immersion. In the prior art processes this was frequently impossible due to the high viscosity. In the prior art, the high viscosity frequently caused cavities to be formed in the impregnated fiber hose during the immersion process. However, immersion offers the advantage that at a sufficiently low viscosity a very homogeneous impregnation can be achieved. Only the special designing of the impregnation composition with the parts by weight of isocyanate according to the invention in relation to the resin allows the material of the fiber hose to be impregnated by immersion without the formation of cavities.

Preferably, in the process according to the invention, the weight proportion of the isocyanate in relation to the resin is adjusted depending on the properties of the components of the impregnation composition such that the viscosity of the impregnation composition does not exceed 1000 mPas during the impregnation process, but amounts to at least 1200 mPas 72 hours after the impregnation process. Thus it can be ensured for the first time that the fiber hose can be impregnated particularly homogeneously and easily during the impregnation process, even by immersion for example, and on the other hand that during the renovation work the impregnation composition does not cause any contamination by flowing out of the fiber hose.

In another embodiment, the object of the invention is achieved by using isocyanate as a thickener for resin in the impregnations of fiber hoses for internal lining of canals and pipelines.

In a last embodiment, the object of the invention is achieved with a canal or a pipeline, characterized in that on the inside a fully hardened fiber hose according to the invention is arranged.

### Embodiment 1 (Comparative Example)

100 parts by weight of the thixotropic polyester resin Crystic U 1037 T of the company Scott Bader were thoroughly and homogeneously mixed with 1 part by weight, 2 parts by weight and 3 parts by weight, respectively, of the MgO paste Luvatol EK 30 NV (30% by weight of MgO). The thickening behavior was observed at room temperature.
1. At 1 part by weight of EK 30 NV no thickening occurred after 144 hours (6 days). After 20 weeks the mixture was still liquid.
2. At 2 parts by weight of EK 30 NV already after 47 hours a thickening occurred which was too strong to ensure the necessary residual flowability. After 20 weeks a hard rubber-like unusable material was obtained.
3. At 3 parts by weight of EK 30 NV a honey-like consistency was obtained after 20 hours. After a total of 47 hours the thickening process had progressed to such an extent that the necessary residual flowability could not be ensured. After 20 weeks a hard rubber-like unusable material was again obtained.

The thickening profile required in the liner technology cannot be obtained with MgO paste. This thickening profile is characterized in that, on the one hand, no resin flows out of the liner erected by compressed air at the lateral cutting edges thereof under gravitational effect. On the other hand, a certain small degree of residual flowability must exist to ensure resin balancing in the area of the kinks of the liner, which are attributable to storage in the transport crate, and thus achieve a uniform wall thickness. Thirdly, the thickening profile required in the liner technology is characterized in that the thickening state remains unchanged to the greatest possible extent over a storage time of 6 months.

### Embodiment 2

An immersion bath was prepared in which the impregnation composition was held available. This impregnation composition contained 100 parts by weight of polyester resin rendered thixotropic (Crystic U 1037 T of the company Scott Bader) and 2 parts by weight of a commercially available isocyanate (Desmodur N100 of the company Bayer). Further, a commercially available UV initiator (radical starter) was added in the usual amount. A glass fiber hose was moved through this immersion bath before the end of a 6-hour period following the mixing of the components of the impregnation composition. This glass fiber hose was a commercially available hose which is typically used for renovating pipes. As is customary, this hose was provided with a UV protection film on its outside, and another film tube was inserted into the hose. This hose was stored for a period of 5 months. Then the hose was inserted into a pipe. The hose was inserted into the pipe such that at both ends of the pipe the hose projected by approximately 1 m. Then the outer protection film was cut open at both ends of the hose. Dripping of the impregnation composition was not observed. Then the packer (the connecting piece) was fitted into the inner film tube at the end of the pipe and connected airtight to the inner film tube. When compressed air was supplied, the fiber hose bore upon the inside of the pipe. A chain of lights comprising UV lamps, which is typically used for this purpose, was inserted into the pipe through the cylinder and switched on to allow complete curing of the resin in the impregnation composition.

The tightness, the mechanical characteristics and the curing rate of this liner corresponded to those of commercially available liners. The viscosity of the impregnation composition was approximately 700 mPas immediately after mixing. During the first 6 hours after mixing the viscosity was not higher than 2,500 mPas. After a 5-month storage time the viscosity of the impregnation composition was higher than 1200 mPas. The viscosity was measured in accordance with the method elucidated in the description.

1. An impregnated fiber hose for internal lining of canals and pipelines, characterized in that the impregnation contains the following components:
a. at least one resin which is not or only partially through-polymerized, and
b. 0.1 to 20 parts by weight of an isocyanate, based on 100 parts by weight of resin.

2. The fiber hose according to claim 1, characterized in that the proportion of the isocyanate ranges between 0.3 and 7 parts by weight, based on 100 parts by weight of resin.

3. The fiber hose according to claim 1, characterized in that the resin is a polyester resin or a vinyl ester resin.

4. The fiber hose according to claim 1, characterized in that the material of the fiber hose is selected from a group consisting of: a woven fabric, a non-crimp fabric, a mat, a cord, a non-woven fabric, a felt and a combination of these textile fabrics.

5. The fiber hose according to claim 1, characterized in that the proportion of inorganic thickener in the impregnation is less than 0.3 parts by weight, based on 100 parts by weight of resin.

6. A process for manufacturing the fiber hose according to claim 1, characterized in that at least the following process steps are carried out:
a) producing an impregnation composition containing at least 0.1 to 20 parts by weight of an isocyanate and 100 parts by weight of unpolymerized resin, and
b) impregnating the material of the fiber hose with the thus produced impregnation composition.

7. The process according to claim 6, characterized in that the material of the fiber hose is impregnated by immersion.

8. The process according to claim 6, characterized in that the weight proportion of the isocyanate based on the resin is adjusted, depending on the properties of the components of the impregnation composition, such that the viscosity of the impregnation composition does not exceed 1000 mPas during the impregnation process, but amounts to at least 1200 mPas 72 hours after the impregnation.

9. A method comprising using an isocyanate as a thickener of resin in impregnations of fiber hoses for internal lining of canals and pipelines.

10. A canal or pipeline, characterized in that on the inside a fully hardened fiber hose according to claim 1 is arranged.

11. The fiber hose according to claim 2, characterized in that the proportion of the isocyanate ranges between 1 and 3 parts by weight, based on 100 parts by weight of resin.

12. The fiber hose according to claim 2, characterized in that the resin is a polyester resin or a vinyl ester resin.

13. The fiber hose according to claim 2, characterized in that the material of the fiber hose is a woven fabric, a non-crimp fabric, a mat, a cord, a non-woven fabric, a felt or a combination of these textile fabrics.

14. The fiber hose according to claim 3, characterized in that the material of the fiber hose is a woven fabric, a non-crimp fabric, a mat, a cord, a non-woven fabric, a felt or a combination of these textile fabrics.

15. The fiber hose according to claim 2, characterized in that the proportion of inorganic thickener in the impregnation is preferably less than 0.3 parts by weight, in particular less than 0.1 parts by weight, based on 100 parts by weight of resin.

16. The fiber hose according to claim 3, characterized in that the proportion of inorganic thickener in the impregnation is less than 0.3 parts by weight, based on 100 parts by weight of resin.

17. The fiber hose according to claim 16, characterized in that the proportion of inorganic thickener in the impregnation is less than 0.1 parts by weight, based on 100 parts by weight of resin.

18. The fiber hose according to claim 5, characterized in that the proportion of inorganic thickener in the impregnation is less than 0.1 parts by weight, based on 100 parts by weight of resin.

19. The fiber hose according to claim 5, characterized in that the proportion of inorganic thickener in the impregnation is less than 0.3 parts by weight, based on 100 parts by weight of resin.
